(19) United States
(12) Patent Application Publication
(10) Pub. No.: US 2008/0269057 A1
(43) Pub. Date: Oct. 30, 2008

(54) Grape Sugar Development

(75) Inventors: Elmar Kerber, Syngenta Crop Protection AG (CH); Duncan McKenzie, Syngenta Crop Protection AG (CH)

Correspondence Address: SYNGENTA CROP PROTECTION , INC.;PATENT AND TRADEMARK DEPARTMENT, 410 SWING ROAD, GREENSBORO, NC, 27409, US

(73) Assignee: SYNGENTA CROP PROTECTION, INC., Greensboro, NC (US)

(21) Appl. No.: 12/097,274

(22) PCT Filed: Nov. 28, 2006
(86) PCT No.: PCT/EP2006/011402

§ 371 Date: Jun. 13, 2008

(30) Foreign Application Priority Data
Dec. 15, 2005 (GB) 0525565.8

(51) Int. Cl. A01N 55/02; A01N 37/44; A01P 21/00

(52) U.S. Cl. 504/190; 504/322

(57) ABSTRACT

Grape sugar development is improved by applying to the vine or to the locus of the vine a composition comprising an iron chelate. Advantages include increasing the overall sugar content of grapes and increasing the rate of development the sugar. A preferred iron chelate is the iron chelate of EDDHA, available commercially as SEQUESTRENE 138 Fe 100.

The present invention relates to improvements in or relating to grape sugar development and more particularly to a method of increasing the rate of development of sugar in grapes and/or the final sugar content of grapes.

Iron is essential for several biochemical and physiological processes inside plants, including the formation of chlorophyll. Since iron has low plant mobility, new growth in plants often shows iron deficiency, particularly in soils that are high in pH, calcareous or have heavy clay content that ties up the iron. It is known to apply iron chelates to plants to counteract iron deficiency. Thus for example the commercial product SEQUESTRENE 138 Fe 100 (SEQUESTRENE is a trademark) is recommended for the correction of iron deficiency in all kinds of crops and ornamentals in alkaline and calcareous soils. SEQUESTRENE 138 Fe 100 has as its active ingredient EDDHA NaFe, which is a mixture of the sodium salt of iron (III) complexes of the two diastereoisomers of Ethylenediamine-N,N′-di(2-hydroxy-phenylacetate) and iron (III) complexes of the two diastereoisomers of ethylene diamine-N-(2-hydroxy-phenylacetate)-N′-(4-hydroxyphenyl acetate). Vines are included in the long list of crops that may be treated with SEQUESTRENE 138 Fe 100.

The sugar content of grapes is of key importance whether for grapes destined for winemaking or for table grapes. Farmers must harvest the grapes at the optimum time to achieve the correct balance of sugar content and the many other factors that go to successful wine making. The desired sugar content depends on the local regulation, on the grape variety and on the use of the grapes (wine or table grapes). The harvesting of grapes is particularly weather-dependent and adverse weather at a late stage in the ripening of grapes may drastically affect the quality and quantity of wines produced. Similarly table grapes are required to have a high sugar content if they are to be acceptable for consumption.

We have now found that, surprisingly, improvements in grape sugar development may be obtained by treating the plants with a compound capable of forming a chelate with iron or a chelate of iron with a chelate-forming compound. The term “improvements in sugar development” includes improvements such as increasing the final sugar content of harvested grapes and/or increasing the rate of development of sugar in grapes, thereby permitting earlier harvesting.

Thus according to the present invention, there is provided a method of improving grape sugar development which comprises applying to the vine or to the locus of the vine a composition comprising (a) a compound capable of forming a chelate with iron or (b) a chelate of iron with a chelate-forming compound.

According to a further aspect of the invention there is provided a method of increasing the sugar content of grapes which comprises applying to the vine or to the locus of the vine a composition comprising (a) a compound capable of forming a chelate with iron or (b) a chelate of iron with a chelate-forming compound.

According to a still further aspect of the invention there is provided a method of increasing the rate of development the sugar content of grapes which comprises applying to the vine or to the locus of the vine a composition comprising (a) a compound capable of forming a chelate with iron or (b) a chelate of iron with a chelate-forming compound.

As used herein, the term “chelate-forming compound” includes any organic substance capable of forming a stable chelate with iron. The chelate-forming compound may be applied to the vine or the locus of the vine in the absence of actual chelation with iron (although chelation may subsequently take place with iron present in the soil) but is preferably applied as a chelate of iron with the chelate-forming compound; i.e. a product in which iron is already bound to the chelate-forming compound.

The chelate-forming compound is preferably soluble or miscible with water both in its unchelated form and as a chelate with iron. As examples of compounds capable of forming a compound with iron and suitable for use in the present invention there may be mentioned ethyelene diamine tetraacetate (EDTA); ethylenetriamine pentaacetate (DTPA); ethylene diamine dihydroxyphenyl acetate (EDDHA); ethylenediamine-di (o-hydroxy-o-methylphenylacetic) acid (EDDHMA); ethylenediamine-N,N′-bis(2-hydroxy-5-sulfonylphenyl) (EDDHSA) and ethylenediamine-di-(2-hydroxy-4-carboxyphenylacetic) acid) (EDDCHA). Iron chelates may be a mixture of isomers, for example commercial EDDHA is mixture of iron (III) complexes of the two diastereoisomers of Ethylenediamine-N,N′-di(2-hydroxy-phenylacetate) and iron (III) complexes of the two diastereoisomers of ethylene diamine-N-(2-hydroxy-phenylacetate)-N′-(4-hydroxyphenyl acetate). Depending on the pH of the composition, the iron chelate may be present in the form of a salt, for example an alkali metal salt such as a sodium salt.

EDDHA NaFe is an especially preferred iron chelate and has an especially favourable physico-chemical behaviour in the soil. The commercial product SEQUESTRENE 138 Fe 100 is a useful source of a chelate of iron with EDDHA.

The chelate-forming compound or iron chelate may be applied in combination with conventional agrochemical adjuvants such as wetters, dispersants, surface-active agents and other activity enhancers. The chelate-forming compound or iron chelate may be formulated as a solution in water or as a solid granule. If a solid granule is employed, the granule may be dissolved in water and applied as a spray or the granules may be applied directly to the soil and leached into the soil under the action of surface water. If the iron chelate is applied as an aqueous spray, either foliar or soil application may be used. In general however soil application is preferred.

The chelate-forming compound or iron chelate may be applied at any desired time and in particular during the early part of the season. The chelate-forming compound or iron chelate may be applied in a single application or by split applications.

The iron content of the composition applied to the vines is preferably from 0% to 50% by weight of composition, for example from 3% to 15% by weight and most preferably from 3% to 12% for example about 6% by weight, based on an application rate of from about 5 g to 100 g of composition (for example of SEQUESTRENE 138 Fe 100) per vine and more particularly an application rate of about 5 g to 25 g of composition per vine

Where vines are grown in soils deficient in available iron, the process of the present invention provides the known benefits of correction of iron deficiency in addition to the surprising benefits of improved sugar development. It is not however essential that the treatment of the present invention is used on vines grown in soils deficient in available iron

The method of the present invention provides an increased sugar content of grapes at harvest compared with untreated vines or in the alternative an increased rate of accumulation of sugar in the grapes compared with untreated vines or both benefits together. It will be appreciated that the faster rate of accumulation of sugar in the grapes permits the farmer to harvest the grapes earlier than would otherwise be the case. Thus if a particular sugar content in the grapes is required, an earlier harvest is achieved than would be possible with untreated vines.

The invention is illustrated by the following Examples in which all parts and percentages are by weight unless otherwise stated.

### EXAMPLE 1

SEQUESTRENE 138 Fe 100 was applied to vines of variety “Superior” grown in soil of pH 8.1. The plot size was 2,700 m² containing 2200 vines/ha. SEQUESTRENE 138 Fe 100 was dissolved in water and applied to the soil via drip irrigation system with 3 mm water/ha at the following crop stages: 1st (6 leaf stage, 10.03.2005), 2nd (inflorescence visible, 20.03.2005), 3rd (beginning of flowering, 07.04.2005) and 4th (end of flowering (20.04.2005). The untreated control received water only All other agricultural measures such as pruning, basic fertilization and irrigation were the same for all treatments. The sugar content of the grapes was measured from 25 bunches per treatment at the intervals indicated in Table 1 (30.05./07.06./13.06/16.06.2005) using a refractometer. The sugar content is expressed as % Brix as used in viniculture. The designation 4×4 kg/ha indicates 4 treatments each of 4 kg/ha and the designation 4×8 kg/ha indicates 4 treatments at 8 kg/ha.

TABLE 1
SUGAR CONTENT ANALYSIS (% Brix)

Date and sugar content

| Treatment | 30.05 | 7.06 | 13.06 | 16.06 |
|---|---|---|---|---|
| Untreated | 11.3 | 12.6 | 13.3 | 13.5 |
| 4 × 4 kg/ha Sequestrene | 12.8 | 14.2 | 14.8 | 15.3 |
| 4 × 8 kg/ha Sequestrene | 13.1 | 14.7 | 15.5 | 15.7 |

It can be seen that the treatment with SEQUESTRENE 138 Fe 100 surprisingly increased the sugar content of the grapes rate dependent such that at the end of the season, the sugar content was increased from 13.5% in the untreated grapes to 15.7% in the grapes having the 4×8 kg/ha. In addition, the increased sugar content at the beginning of the ripening time indicates an accelerating effect of Sequestrene and would enable the farmer to start harvesting 8-10 days earlier than with the untreated control.

1. A method of improving grape sugar development which comprises applying to the vine or to the locus of the vine a composition comprising (a) a compound capable of forming a chelate with iron or (b) a chelate of iron with a chelate-forming compound.

2. A method of increasing the sugar content of grapes which comprises applying to the vine or to the locus of the vine a composition comprising (a) a compound capable of forming a chelate with iron or (b) a chelate of iron with a chelate-forming compound.

3. A method of increasing the rate of development the sugar content of grapes which comprises applying to the vine or to the locus of the vine a composition comprising (a) a compound capable of forming a chelate with iron or (b) a chelate of iron with a chelate-forming compound.

4. A method according to claim 1 wherein the chelate-forming compound is ethylene diamine dihydroxyphenyl acetate.

5. A method according to claim 1 wherein the chelate-forming compound (a) or the iron chelate (b) is formulated as a solution in water or as a solid granule.

6. A method according to claim 1 wherein the chelate-forming compound (a) or the iron chelate (b) is applied by soil application.

7. A method according to claim 1 wherein the iron content of the composition applied to the vines is from 0% to 50% by weight of composition based on an application rate of from about 5 g to 100 g of composition per vine.

8. A method according to claim 1 wherein the iron content of the composition applied to the vines is from 3% to 12% by weight of composition based on an application rate of from about 5 g to 100 g of composition per vine

9. A method according to claim 1 wherein the iron content of the composition applied to the vines is from 3% to 12% by weight of composition based on an application rate of from about 5 g to 25 g of composition per vine.
